(19) United States
(12) Patent Application Publication
(10) Pub. No.: US 2013/0142195 A1
(43) Pub. Date: Jun. 6, 2013

(54) COMPUTER SYSTEM FABRIC SWITCH

(71) Applicant: Gregg B. Lesartre, Ft. Collins, CO (US)

(72) Inventor: Gregg B. Lesartre, Ft. Collins, CO (US)

(21) Appl. No.: 13/809,452

(22) PCT Filed: Sep. 14, 2010
(86) PCT No.: PCT/US10/48694

§ 371 Date: Jan. 10, 2013

(51) Int. Cl. H04L 12/56

(52) U.S. Cl. CPC H04L 49/254
USPC 370/355

(57) ABSTRACT

A fabric switch includes ports, a location function, component, and a routing function component. Packets are received and forwarded via the ports. The location function component provides for determining a location of routing information within a received packet of rooting information based at least in part on the input port at which said packet was received. The routing function component provides for determining an output port as a routing function based at least in part on the contents of said location.

### BACKGROUND

Separate computer nodes can function together as a single computer system, by communicating with each other over a fast computer system fabric. For example, a blade system can include a chassis arid blades installed in the chassis. Each blade can include one or more processor nodes; each processor node can include one or more processors and associated memory. The chassis can include a fabric that connects the processor nodes so they can communicate with each other and access each other's memory so that the collective memory of the connected blades can operate coherently. Fabrics can be scaled up to include links that connect fabrics that connect blades. In such cases, there are often multiple routes between a communication's source and destination.

To route communication packets properly, a fabric can include one or more switches with multiple ports. Typically, a switch examines a portion of each received packet for information pertinent to routing, e.g., the packet's destination. The location of the portion, of the packet header examined can vary according to the communication protocol used by the blade system. The switch, then selects an output port based on the routing information.

### BRIEF DESCRIPTION OF THE DRAWINGS

FIG. 1 is a schematic diagram of a fabric switch in accordance with an embodiment.

FIG. 2 is a flow chart of a fabric-switch process In accordance with an embodiment.

FIG. 3 is a schematic diagram, of a computer system in accordance with an embodiment.

FIG. 4 is a flow chart of a process employed in the context of the computer system of FIG. 3.

FIG. 5 is a schematic diagram of another computer system employing fabric switches in accordance with an embodiment.

### DETAILED DESCRIPTION

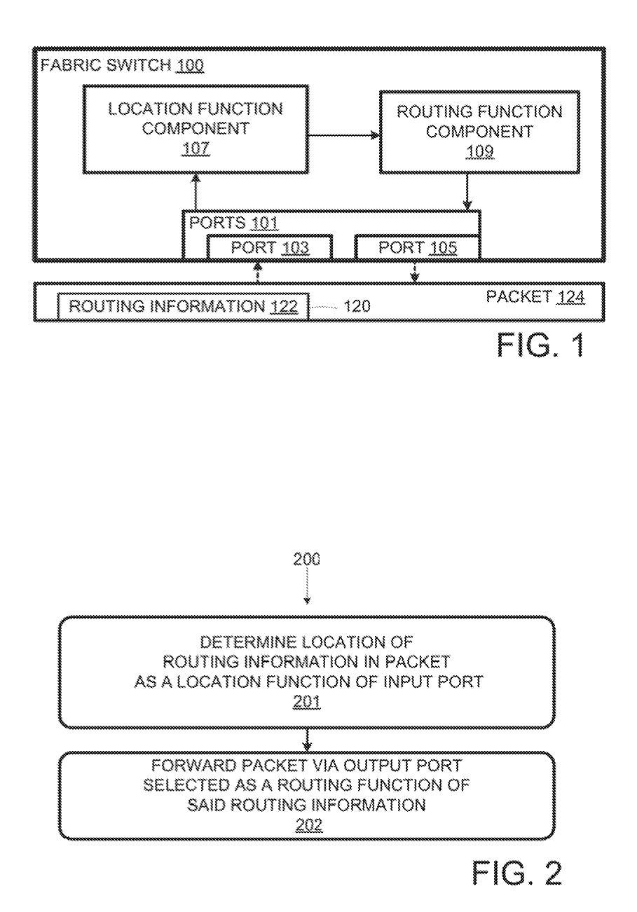

A fabric switch 100 includes ports 101, Including ports 103 and 105, a location function component 107 and a rooting function component 100, as shown in FIG. 1 Fabric switch 100 implements a process 200 flow charted in FIG. 2. At process segment 201, the location function component 107 determines a location 120 of routing information 122 in a packet 124 as a location function of the port 107 at which packet 124 was received. At process segment 202, the packet is forwarded out a port 109 selected as a rooting function (implemented by routing function component 109) of routing information 122. Thus, process 200 allows proper routing determinations to be made despite the use of different protocols at respective real or virtual ports of a switch.

A blade computer system 300 includes a chassis 301, blades 303, including blades B1-B8, and a fabric module 305. Fabric module 305 includes at least portions of links 307, e.g., links L1-L8, and a fabric switch 310. Fabric switch 310 includes a processor 311, media 313 encoded with code 315, and ports 317, e.g., ports P1-P8. Code 315 is configured to, when executed by processor 311, define a database 317 and functionality for a link Interface 320 of switch 310. Code 315 further serves to define a link Interface 320 with an Initialization manager 321 and a packet manager 323. Packet manager 327 includes a location function component 325 and a routing function component 327, Database 317 includes an input table 331, an output table 333, environmental data 335, allocation policies 337, and visualization information 339. In an alternative embodiment, a processor external to a fabric switch executes software to configure the fabric switch to read the rooting field of a packet, perform a conversion as appropriate, and lookup the output port.

Input table 331 uses input port identity as a key field. Associated with each input port identity is an offset, a bit length, and a conversion function. The offset and length, define a routing field location, typically in the packet header, which bears routing information used to determine which output port through which to forward a packet. This location is protocol dependent.

In some cases, the value at the indicated location can be used directly as an index to output table 333. In other cases, some conversion function, identified in the rightmost column of table 331, can be applied to obtain the Index value to be input to output table 333. For example, for input link identities L3 and L4, the extracted value is to be decremented by unity to yield the Input to output table 331. For link identity L4, the source link Identity value (e.g., 4) is added modulo-8 to the extracted value to determine the value to be input to table 333. For input link L5, four bits are extracted, but the third is ignored. The conversions are tied to the protocols employed by the input links.

In practice, the conversions can be performed using table Look-ups. As explained further below, in some cases, the conversions may take into account environmental data, allocation policies, and virtualization information. Once the packet value is extracted/converted, it can be input to output table 333 which, associates the packet value with an output port.

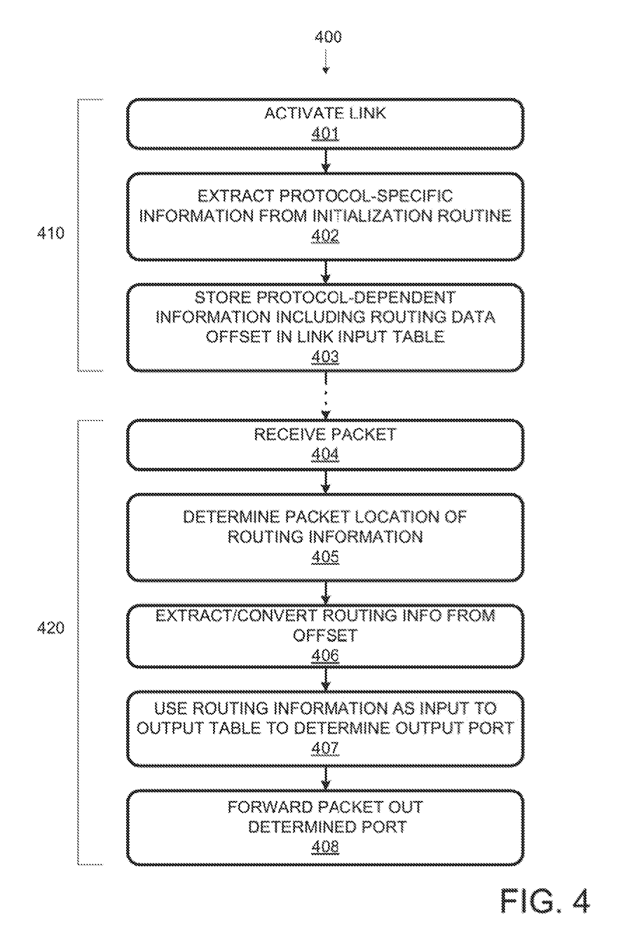

A process 400 implemented by blade system 300 and switch 310 includes a configuration phase 410 and a packet phase as flow charted in FIG. 4. Configuration phase 410 includes a process segment 401 in which a link is activated. This activation may be initiated at a blade or other end node, either as the node is booted or when a link-specific interface of the end node is activated. The activation typically involves an exchange of protocol information. Accordingly, protocol-dependent (i.e., protocol-specific) information can be extracted, during link initialization at process segment 402. This protocol-dependent information can Include an explicit identification of the location at which routing Information can be found Alternatively, the protocol can. he identified and the location for the protocol, can be “looked up”, e.g., in a table resident on switch 310. At process segment 403, the extracted information can he stored in input table 331 in terms of a header location offset and a bit-length following the offset. Likewise, conversion information for table 331 can be obtained in explicit form from die header location or inferred from the protocol identity from a table in database 317. This completes a setup phase for process 400.

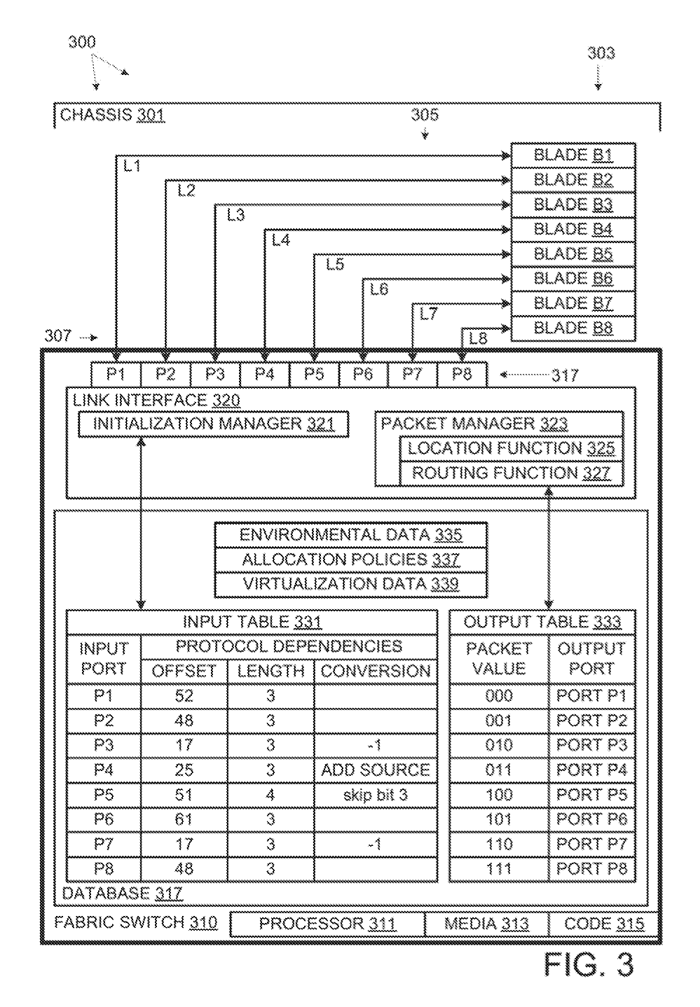

Packet phase 420 of process 400, as flow charted in FIG. 4, begins with receipt of a packet at a port at process segment 404. At process segment 405, location function component 325 (FIG. 3) uses input table 331 to determine the packet location of routing information by looking up the location as a function of the port at which the packet was received. At process segment 406, packet manager 323 extracts the routing information from the determined location of the packet. Depending on the information in the conversion column of table 331, this routing information can be used directly or converted by routing function component 327. In any case, the resulting value can be input to output table 333 at process segment 407 to select apart for outputting the packet. At process segment 408, the packet is forwarded out the selected port.

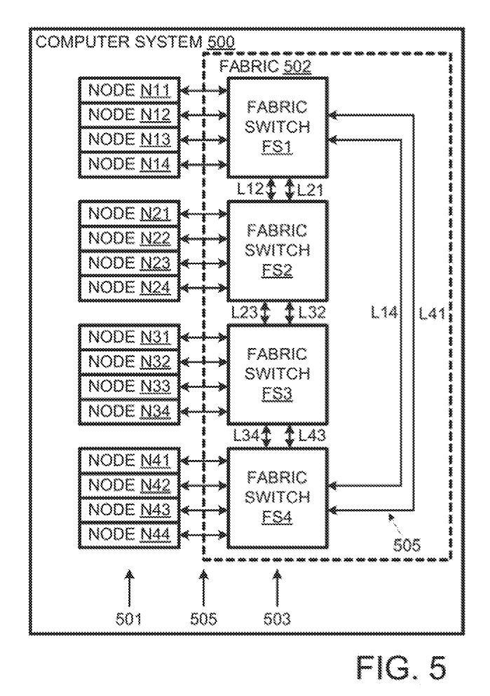

A computer system 500 includes end nodes 501 and fabric 502, as shown in FIG. 5. Fabric 502 includes fabric switches 503 and links 505. End nodes 501 include nodes N11-N44. Fabric switches 503 include fabric switches FS1-FS4. Links 505 include links L11-L43, as well as unlabeled links to end nodes SOL. Nodes 501 can be of various types with including without limitation processor nodes, network (e.g. Ethernet) switch nodes, storage nodes, memory nodes, and storage network, nodes that provide interfacing to mass storage devices. Each fabric switch 503 has eight ports, four of which are shown connected to respective nodes and four of which are shown connected to other fabric switches.

Accordingly, there is a choice of fabric routes between each pair of nodes. In fact, in system 500, there are ten possible fabric routes between each pair of end nodes. For example, node N11 can communicate with node N21: 1) using link L12; 2) using link 121; 3) using the link combination L14, L34, and L23; 4) using the link combination L14, L34, and L32; 5) using the link combination L14, L43, L23; 6) using the link combination L14, L43, and L32; 7) using the link combination L41, L34, and L23; 8) using the link combination L41, L34, and L32; 9) using the link combination L41, L43, and 123; and 10) using the link combination L41, L43, and L32.

In most cases, one of the two more direct routes via links L12 and L21 would be used, in communicating between nodes N11 and N21. Of these two, the least milled could be selected. In some cases, links L12 and L21 might be so heavily utilized that communication through one of the other eight routes might be faster and more reliable. So that utilization can be taken into account when a switch makes routing decisions, each switch FS1-FS4 can monitor utilization at each of its ports and communicate summary information to the other fabric switches. Each fabric switch stores utilization data as environmental data 335 (FIG. 3), Environmental data 335 can also Include non-utilization data, such as the average number of retries required to successfully transmit a packet over a link. Such other environmental data can also be used by a switch in making routing determinations. In other embodiments, e.g., in which a protocol is not compatible with dynamic routing, dynamic rooting is not employed.

Switches FS1-FS4 can be configured to treat all packets equally. Alternatively, switches FS1-FS4 can be programmed with allocation policies 337 (FIG. 3) that cause packets to be treated with different priorities according to source, destination, protocol, content, or other parameter. For example, if there is not enough direct inter-switch bandwidth to handle both real-time and non-real time packets, non-real-time packets can be redirected along an Indirect route. Also, some nodes may be associated with more important users; in that case, traffic associated with other users can be sent along slower routes or even dropped to favor the more important users. In an alternative embodiment, traffic is not prioritized.

Other embodiments providing for inter-switch communications can include different numbers and types of end nodes, different numbers of links associated with nodes, different numbers of inter-switch links, different numbers of ports per switch. Also, the algorithms applied to allocate traffic among alternative routes ran vary from those described for system 500.

Visualization data 339 can include data regarding various visualization schemes including virtual links and virtual channels. An implemented visualization scheme can then be reflected in the allocation policies 337 and environmental data 335. For example, a physical link, e.g., line L12, can be time-multiplexed to serve as several virtual links. Each port connected to the link can have a separate first-in first out FIFO buffer for each virtual link, thus defining virtual ports associated with each real, fabric switch port. This permits packets sent along different virtual links to progress at different rates depending on virtual link usage.

Virtual channels can be used to handle sessions of packets. For example, it may he desirable to send an acknowledgement packet along the reverse of the route along which the original packet was sent, in other cases, it may be desirable to maintain the same forward and reverse routes for several packets of a “session”. To this end, the packets can. he assigned, to a virtual channel and the virtual channel can he assigned to a forward and reverse pair of routes. Thus, a series of packets between node N11 and node N31 could all be assigned (using header information) to a given virtual channel; visualization data 339 can then specify a mapping of the virtual channel to forward and reverse fabric routes.

Fabric switches 100 (FIG. 1), 310 (FIG. 3) and FS1-FS4 (FIG. 5) are, in effect, programmable to handle different: fabric protocols on a per-port basis. In alternative embodiments, a switch can he programmed to handle different protocols on a per-virtual-link or per-virtual-channel basis. This gives the computer system owner great flexibility In terms of configuring and upgrading, For example, doting the lifetime of an Initial set of end nodes, improved end nodes may have been introduced providing for a new fabric protocol for improved performance. In system 500, each end node can be replaced at an optimal time (e.g., as it begins to be unreliable or as it becomes a bottleneck) with a new generation, end node. The illustrated fabric switches can handle a combination, of old and new generation end nodes even though the protocols they support store routing information in different places in the transmitted packets.

Unless context indicates otherwise, “port” and “link” can refer to either a real or virtual entity. As used herein, “processor” refers to a hardware entity that can be part of an integrated circuit, a complete integrated circuit, or distributed among plural integrated circuits. Herein, “media” refers to non-transitory, tangible, computer-readable storage media. Unless context Indicates that only a software aspect is under consideration, switch components labeled as “managers” or “component” are combinations of software and the hardware used to execute the software.

Herein, a “system”* is a set of interacting elements, wherein, the elements can he, by way of example and not of limitation, mechanical components, electrical elements, atoms, instructions encoded in storage media, and process segments. In this specification, related, art is discussed for expository purposes. Related art labeled “prior art”, if any, is admitted prior art. Related art not labeled “prior art” is not admitted prior art. The Illustrated and other described embodiments, as well as modifications thereto and variations thereupon are within the scope of the following claims.

What is claimed is:

1. A fabric switch, comprising:
ports through which packets arc received, and forwarded;
a location function component for determining a location of routing information within a received packet containing routing information based at least in part on the input port at which said packet was received, and
a routing function component for determining an output port as a routing function based at least in part on said routing information.

2. A fabric switch as recited, in claim 1 further comprising an initialization manager configured to:
activate a link connecting an end node to a port of said switch so as to establish a protocol to which communications over said link are to conform; and
in response to said activating, generate or adjust said location function to correspond to the use of said protocol at that port,

3. A fabric switch, as recited in claim 2 wherein, said ports are real ports.

4. A fabric switch as recited in claim 2 wherein said ports include both real, and virtual ports, said, virtual ports including said input port and said output port.

5. A fabric switch as recited in claim 2 wherein said determining said output port is a routing function at least in part of a virtual channel to which said packet is assigned.

6. A fabric switch process comprising:
a switch determining a location of routing information within a packet as a location function of a first port at which said packet was received; and
said switch forwarding said packet out of a second port of said switch selected as a routing function of said routing information.

7. A process as recited in claim 8 further comprising:
before said receiving, engaging in activating a link to said first input port so that communications over said link conform to a first fabric protocol; and
generating or adjusting said location function as a function of said first fabric protocol.

8. A process as recited in claim 7 further wherein said ports are real ports.

9. A process as recited in claim 7 wherein said ports are virtual ports.

10. A process as recited in claim 7 wherein said determining said output port is a function at least in part of a virtual channel to which said packet is assigned.

11. A computer product composing media encoded with code configured to, when executed by a processor,
implement an input function including determining a packet location as a location function of an input port at which a packet was received, and determine a routing value as a routing function of a packet value extracted from said packet location;
forward said packet via an output port determined at least in part as a port function of said routing value.

12. A computer product as recited in claim 11 wherein said code is further configured to:
before said receiving, engaging In activating a link to said first input port so that communications over said link conform to a first fabric protocol; and
generating or adjusting said location function as a function of said first fabric protocol.

13. A computer product as recited in claim 12 further wherein said ports are real ports.

14. A computer product as recited in claim 12 wherein said ports are virtual ports.

15. A computer product as recited in claim 12 wherein said determining said output port is a function at least in part of a virtual channel to which said packet is assigned.
